(19) United States
(12) Patent Application Publication
(10) Pub. No.: US 2026/0270189 A1
(43) Pub. Date: Sep. 10, 2026

(54) PACKET DEDUPLICATION WITH EPOCHS

(71) Applicant: NVIDIA Corporation, Santa Clara, CA (US)

(72) Inventor: Hans Eberle, Los Angeles, CA (US)

(21) Appl. No.: 19/071,603

(22) Filed: Mar. 5, 2025

(51) Int. Cl. H04L 45/021; H04L 5/00

(52) U.S. Cl. CPC H04L 45/021; H04L 5/0055

(57) ABSTRACT

Establish a process to identify non-idempotent packets of data communicated over a computing network between two nodes within an epoch to determine if a duplicate packet of data is received. The transmitter of the packet of data and the receiver of the packet of data establish an epoch where packets of data received within the epoch are considered packets that are to be processed, e.g., checked, if necessary if it is a duplicate packet. Packets received outside of the epoch can be processed, ignored, or buffered depending on the processes used by the two nodes. The time span of the epoch can be determined by the anticipated number of packets that will be received during the epoch and the available memory allocation to store unique signatures of the packets of data. The unique signatures can be a unique packet identifier or a combination of a packet type and identifier.

### TECHNICAL FIELD

This application is directed, in general, to network communications and, more specifically, to handling duplicate communication packets.

### BACKGROUND

In network communications, packets of information can be sent from a transmitter node to a receiver node, each being coupled to the network. For example, the Internet Protocol (IP) used on the World Wide Web is a packet protocol. Packets can be received out of order at the receiver node. A duplicate packet can be sent as well, such as when the transmitter node does not receive a confirmation of receipt of the packet. In some scenarios, duplicate packets can cause problems, such as causing a double execution of a task instead of just one execution of a task. Better handling of duplicate packets could improve overall network communications.

### SUMMARY

In one aspect, a method is disclosed. In one embodiment, the method includes (1) establishing a packet handling protocol at a node, wherein the packet handling protocol specifies using an epoch counter at the node, the node is communicatively coupled to a computing network, and the epoch counter is initialized to a current value, (2) receiving a packet of data at the node, wherein the packet of data is non-idempotent and includes an epoch value, and (3) determining an action for the packet of data by comparing the epoch value to the current value of the epoch counter.

In a second aspect, a system is disclosed. In one embodiment, the system includes (1) a first node on a computing network capable of transmitting and receiving packets of data over the computing network, and (2) a second node on the computing network capable of transmitting and receiving the packets of data over the computing network, wherein the second node utilizes an epoch counter, the packets of data include at least one non-idempotent packet of data, and the at least one non-idempotent packet of data includes an epoch value and a respective unique signature, and determining an action for the at least one non-idempotent packet of data by comparing the epoch value to the epoch counter.

In a third aspect, a non-transitory computer program product having a series of operating instructions stored on a non-transitory computer-readable medium that directs packet deduplication when executed thereby to perform operations is disclosed. In one embodiment, the operations include (1) establishing a packet handling protocol at a second node, wherein the packet handling protocol specifies using an epoch counter at the second node, and the second node is communicatively coupled to a computing network, (2) transmitting a packet of data across a computing network from a first node, wherein the first node is communicatively coupled to the computing network. (3) receiving a packet of data at the second node, the packet of data is non-idempotent, and the packet of data includes an epoch value and a unique signature, and (4) determining an action for the packet of data by using the unique signature and comparing the epoch value to the epoch counter.

### BRIEF DESCRIPTION

Reference is now made to the following descriptions taken in conjunction with the accompanying drawings, in which:

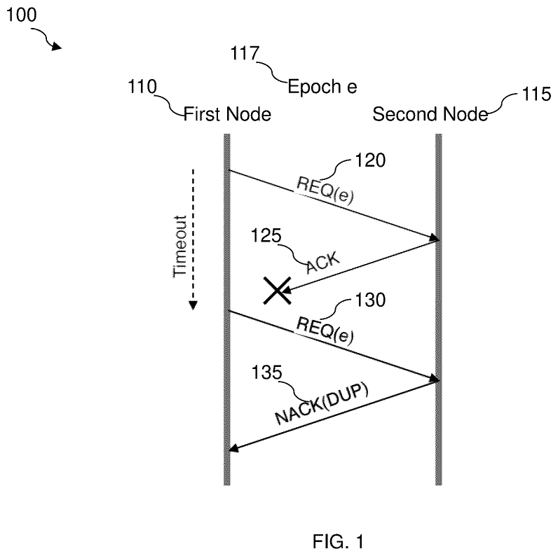

FIG. 1 is an illustration of a diagram of an example process using epochs for deduplication;

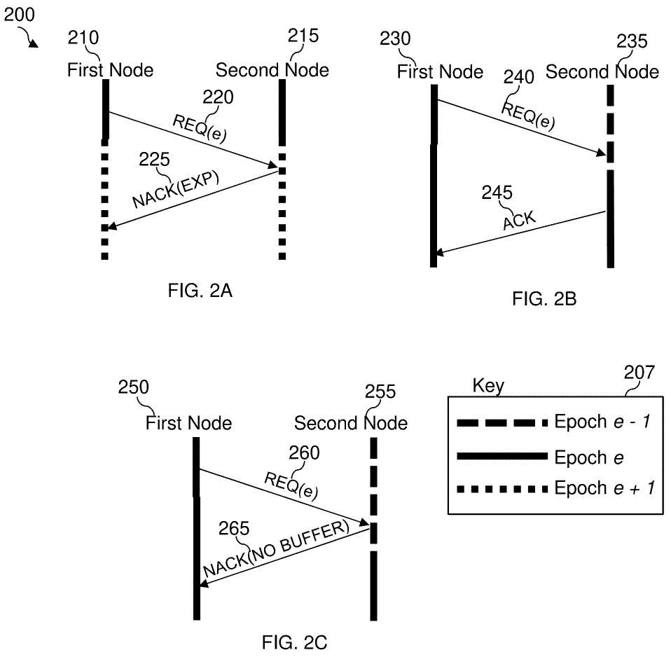

FIGS. 2A-2C are illustrations of diagrams of example processes when epochs do not match between the source node and destination node;

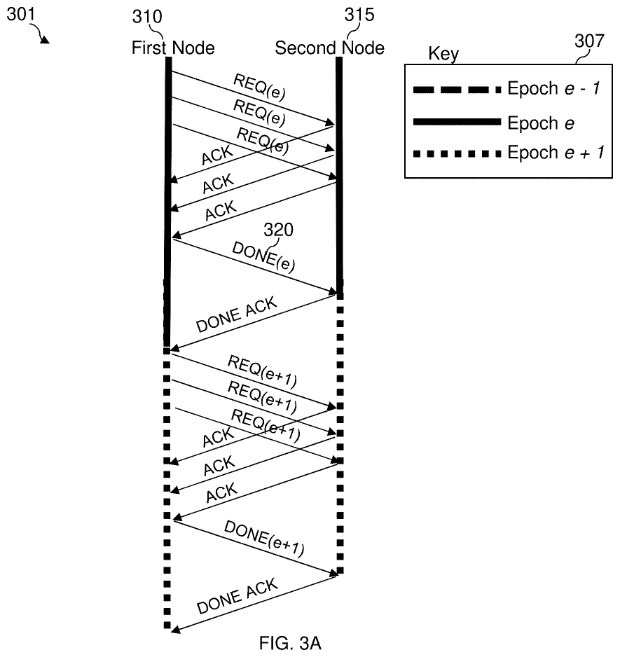

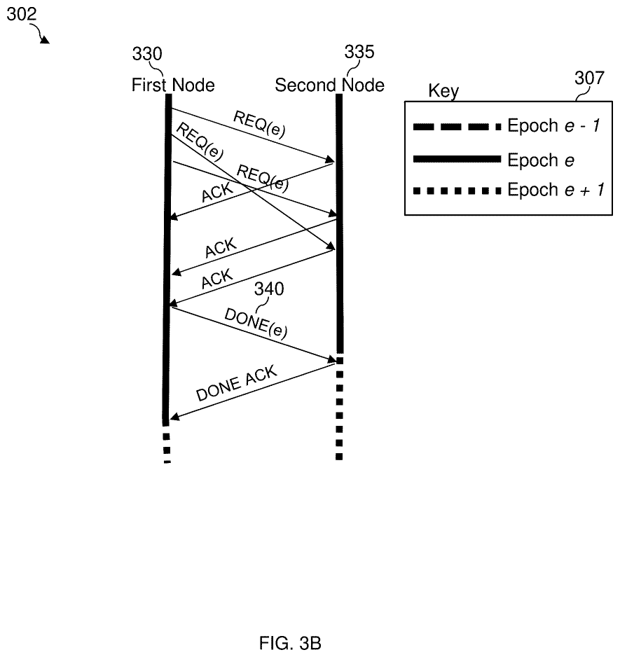

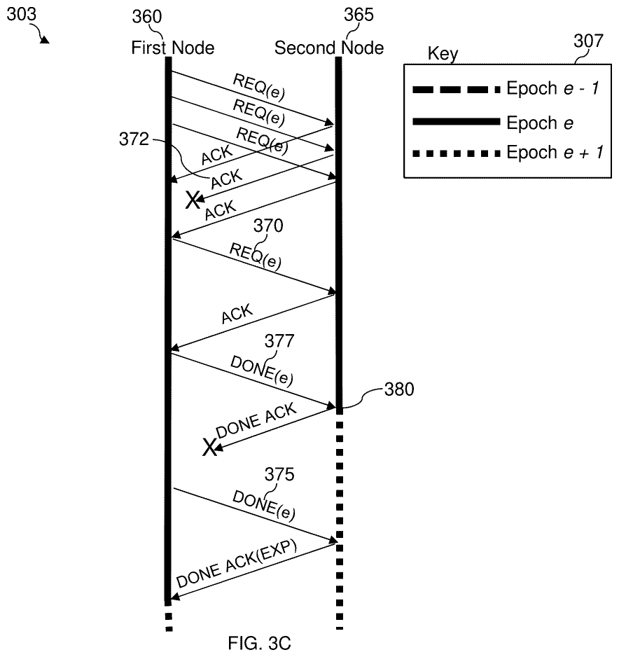

FIG. 3A is an illustration of a diagram of an example bulk data transfer;

FIG. 3B is an illustration of a diagram of an example bulk data transfer for ordering packets;

FIG. 3C is an illustration of a diagram of an example bulk data transfer for handling duplicates;

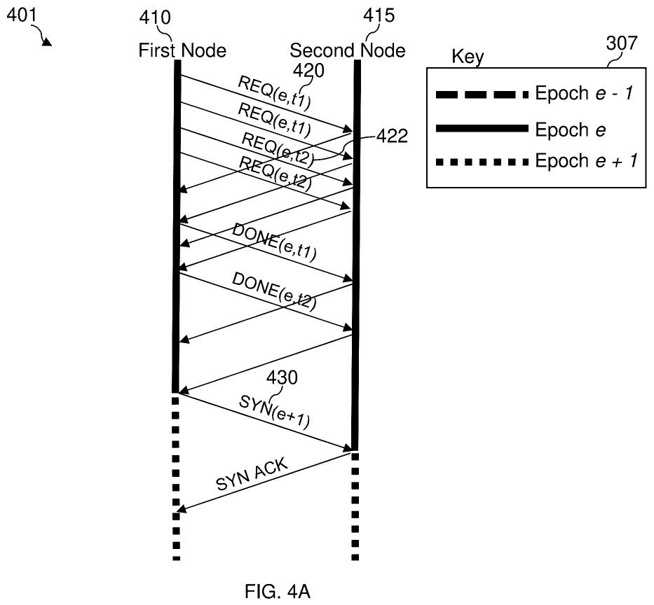

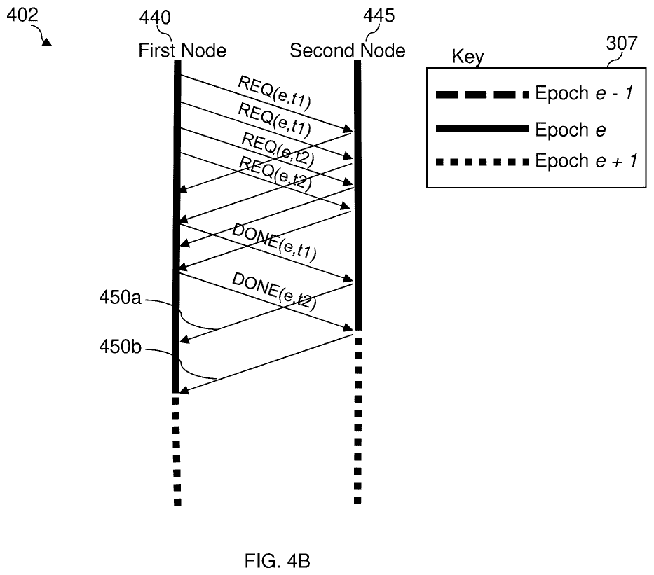

FIG. 4A is an illustration of a diagram of an example multiple transfers per epoch;

FIG. 4B is an illustration of a diagram of an example multiple transfers per epoch;

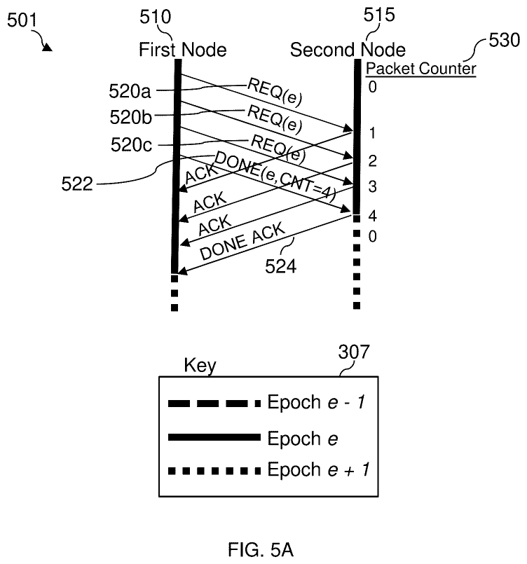

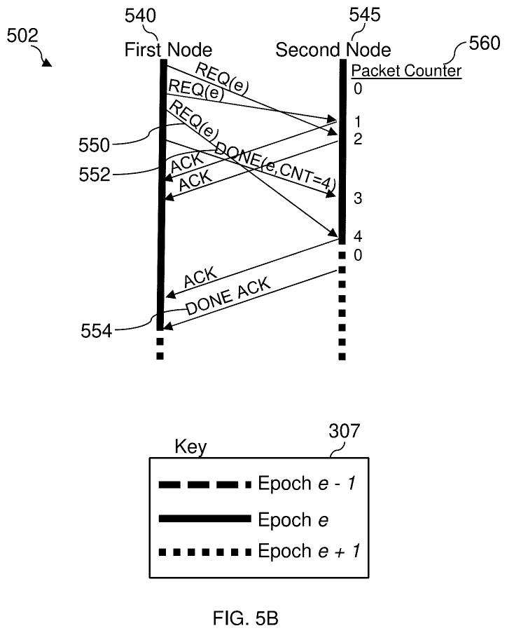

FIG. 5A is an illustration of a diagram of an example destination node synchronization;

FIG. 5B is an illustration of a diagram of an example destination node synchronization with out of order packets;

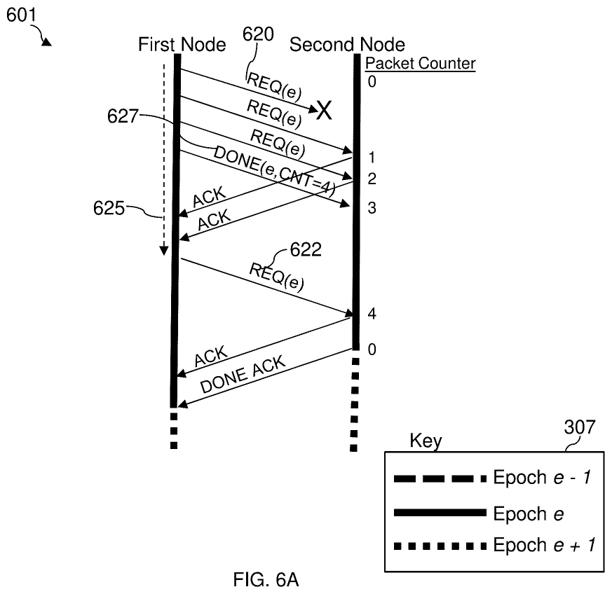

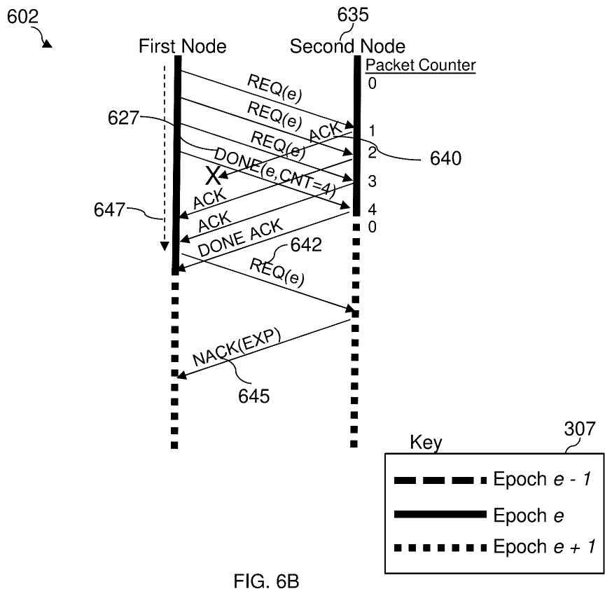

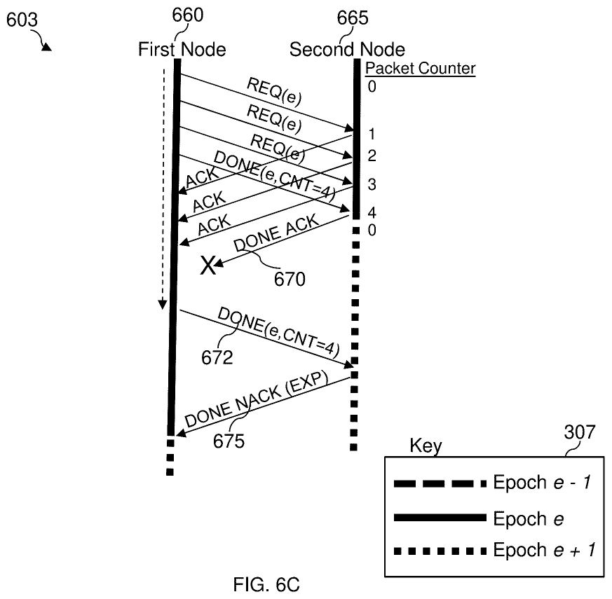

FIG. 6A is an illustration of a diagram of an example lost packet protocol;

FIG. 6B is an illustration of a diagram of an example lost packet protocol when an ACK packet is lost;

FIG. 6C is an illustration of a diagram of an example lost packet protocol when a DONE ACK packet is lost;

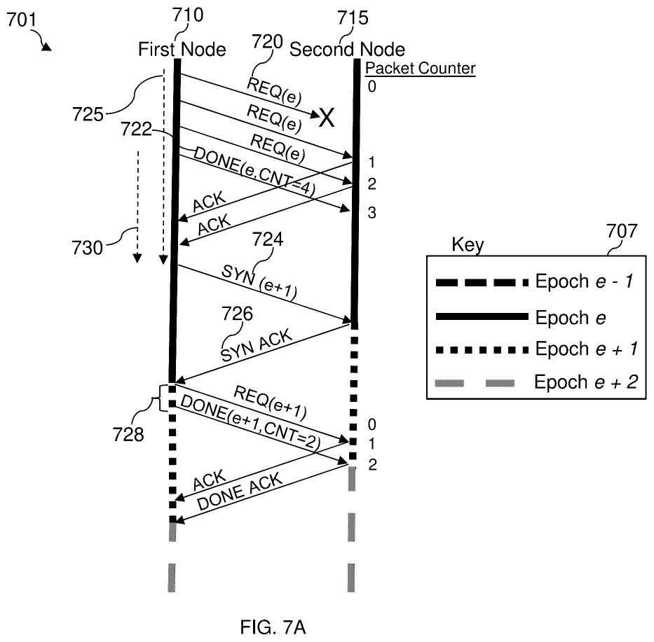

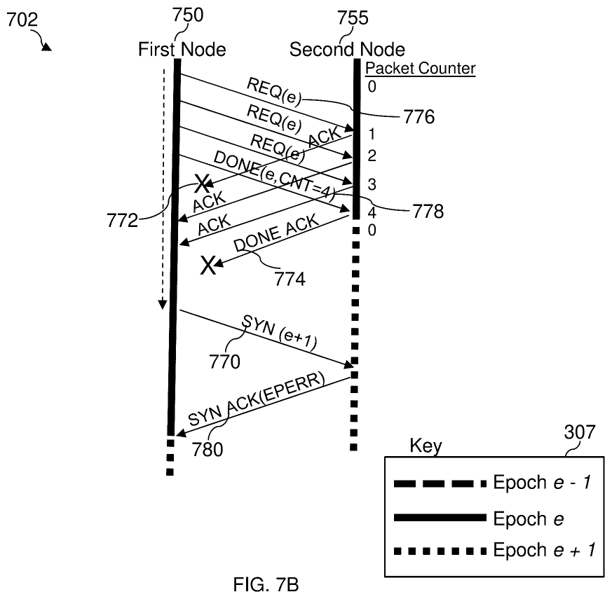

FIG. 7A is an illustration of a diagram of an example lost packet protocol demonstrating a process that does not need non-idempotent REQ packets;

FIG. 7B is an illustration of a diagram of an example lost packet protocol demonstrating waiting for the completion of the SYN/SYN ACK handshake before retrying transactions;

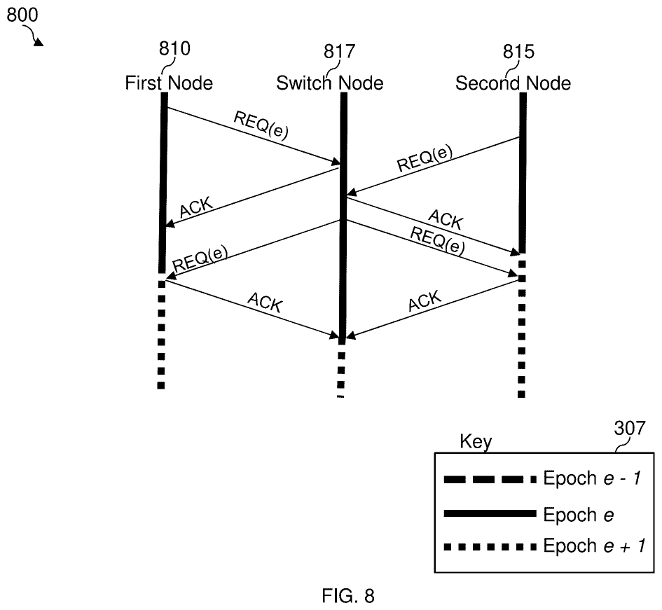

FIG. 8 is an illustration of a diagram of an example collective to demonstrate a channel that comprises more than two nodes;

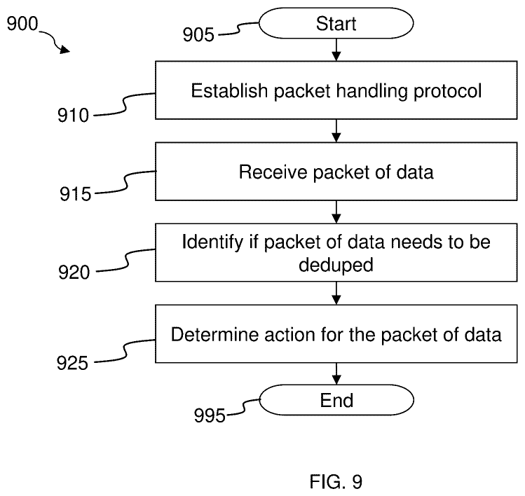

FIG. 9 is an illustration of a flow diagram of an example method to perform a deduplication process of a packet of data;

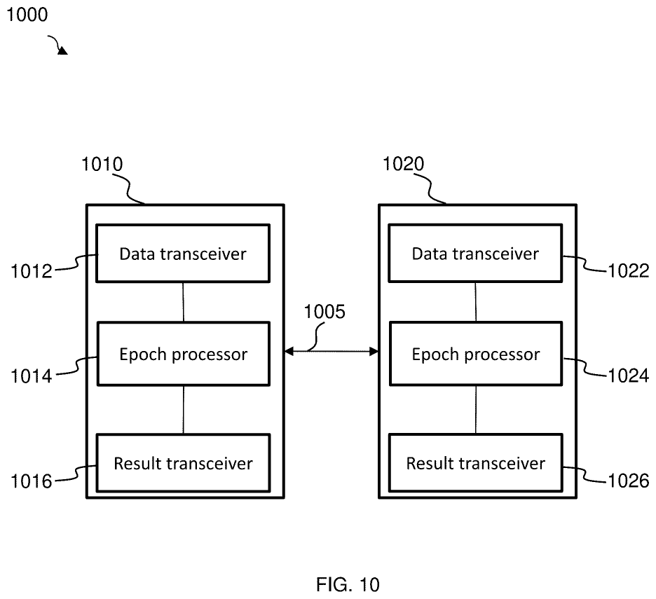

FIG. 10 is an illustration of a block diagram of an example epoch system; and

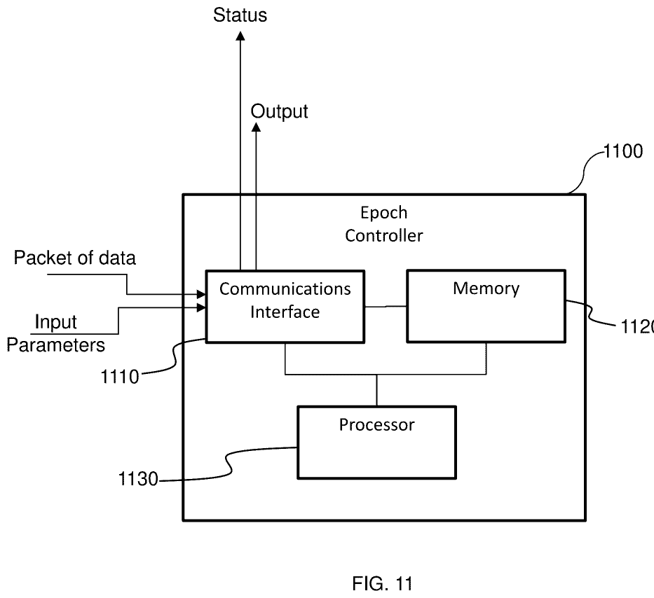

FIG. 11 is an illustration of a block diagram of an example of an epoch controller according to the principles of the disclosure.

### DETAILED DESCRIPTION

Network communications (e.g., communications across a computing network) between at least two nodes of the network can use a packet protocol. A packet protocol can define the structure and format of the packets that are sent across a network. The packet can include at least a destination address, for example a destination Internet Protocol (IP) address and information. The information can be data, instructions, or a combination of these elements, for example, data can be part of a streaming video, or instructions can be banking instructions. In some aspects, the packet can include the source address of the transmitting node. The packets can use other protocols, for example, transmission control protocol (TCP), user datagram protocol (UDP), hypertext transfer protocol (HTTP), file transfer protocol (FTP), simple mail transfer protocol (SMTP), domain name system (DNS), dynamic host configuration protocol (DHCP), simple network management protocol (SNMP), or Telnet. Another example of a packet protocol is NVLink which allows for unified memory pooling across multiple graphic processor units (GPUs). In this example, packets transport operations to access memory across the network.

The computing network can be one or more various types of networks, for example, wired networks, wireless networks, closed networks, intranets, internets, extranets, or various combinations thereof. The computing network can be a network coupling chips within a computing system, coupling components of a circuit board, coupling chips within a circuit board or computing system, coupling processor units (e.g., GPUs, central processor units (CPUs), or types of processors), coupling processor cores, or various combinations thereof. The networks can be used in one or more environments, for example, on the Earth's surface, downhole a borehole, under water, in the atmosphere, in space, on or around one or more celestial bodies, or other environments. The networks can be used for vehicle communications, for example, robots, automated systems, automobiles, boats, ships, satellites, spacecraft, or other vehicles.

The transmitting node (e.g., the transmitter node or source node) and the receiving node (e.g., the receiver node or destination node) are communicatively coupled to the network and are able to establish a communication link between the source node and the destination node. Source and destination indicate the communication direction of a particular packet, and for a different packet, each node can be the source or destination node depending on which node is communicating the packet. The source node or the destination node can be an electronic device, (such as a computing device, smartphone, laptop, server, or other electronic device), a system, (such as a virtual system, an application, a code library, a function, a system port, or other types of systems), a hardware device (such as a memory location, a processor, a physical port, a machine, or other hardware devices), or various combinations thereof.

A source node can send one or more packets through the network to the destination node. The packets can be delivered in various orders. In some aspects, the source node can request or expect a reply packet indicating that the first packet or packets were received properly at the destination node. For example, a first packet containing a bank transfer can be received at a first destination node and the first destination node (now acting as a second source node) can send a confirmation packet back to the first source node (which is now a second destination node). If the confirmation packet is not received, the first source node can send a duplicate first packet. When the duplicate first packet is received at the first destination node, the bank transfer action may be completed a second time if a deduplication of the first and duplicate first packets is not handled properly.

Duplicate packets in networks can lead to erroneous outcomes. An example is a packet that carries an atomic operation that is to be executed once. Duplicate packets can occur for varied reasons. Lossy networks, in particular, have this problem. An example is a transaction-based protocol where an acknowledgment packet confirming receipt of a request packet is lost. This can cause the request packet to be retransmitted and delivered a second time.

This disclosure presents processes to implement a unique signature for each packet that the destination node can memorize and use to recognize later duplicate packets. Epochs can be used to constrain the number of signatures that are to be tracked. The source node and the destination node can maintain loosely synchronized epoch counters (e.g., epoch synchronization), for example, the source node can attach the current epoch value to each packet injected into the network while the destination node processes packets with an epoch value that matches its epoch counter value. Received packets with a previous epoch value can be aged out, in some aspects, they can be ignored. To recognize duplicates, the destination node can maintain a deduplication filter that stores the signatures of the packets received during the current epoch.

Epochs can form a coarse-grained timeline that allows for limiting the time interval (e.g., an epoch time interval) for recognizing packet duplicates. Rather than using a global time base to synchronize source nodes and destination nodes, protocol handshakes can be used to move the timeline forward. The disclosed processes do not impose ordering requirements when packets are delivered, providing flexibility in packet processing. The epoch approach can provide advantages over conventional solutions: (1) The epoch approach can support loose synchronization between nodes. (2) The epoch approach can be tolerant of clock drift and network delays. (3) The epoch approach can reduce the storage resources needed for a deduplication filter.

Improvement in network communications can be achieved in various types of networks. In some aspects, networks with the following properties can see improvement in communication efficiency: (1) Sparse Connectivity: Nodes can typically communicate with a small number of other nodes. These connections can be long-lasting, persisting over extended periods of time. (2) Idempotency: Most packets can tolerate “at-least-once” delivery, meaning they can be received multiple times without adverse effects. There can be a few packets that are to be delivered “exactly once” requiring deduplication. (3) Delivery Order: Packets can be delivered out of order and do not require in-sequence delivery. Out-of-order delivery can be a common occurrence in networks due to various factors such as dynamic routing and multipathing. For example, these characteristics can be notably common to network traffic characteristics of Large Language Model (LLM) training. This disclosure uses a load/store model for demonstration purposes, while the disclosed processes can be utilized for deduplication in a broad range of network protocols.

Epochs can provide a process to maintain a loose sense of synchronized time without requiring precise clock synchronization. The epochs can utilize: (1) Epoch Counters: Each set of communicating nodes can maintain its own set of epoch counters. These epoch counters can be incremented periodically, creating coarse time intervals that advance at a much slower rate than real-time. In some aspects, an epoch can be incremented at the end of an epoch time interval regardless of the packets of data received. The epoch time interval counter can be reset for the subsequent epoch.
(2) Packet Timestamping: When a source node transmits a packet, it can include the current epoch value, for the source node, in the packet, such as in the header. This inclusion can serve as a coarse timestamp, indicating approximately when the packet was sent.
(3) Epoch Comparison: Upon receiving a packet, the destination node can compare the packet's epoch value to its own current epoch value. If the packet's epoch is behind the destination node's epoch, the packet can be considered to have aged out and is not processed. Conversely, if the packet's epoch is ahead of the destination node's epoch, the packet can be considered to be from the future and may be either buffered or discarded, depending on the specific implementation or available resources. When the packet's epoch matches the destination node's epoch, the packet is deemed valid and is processed normally, for example, having a deduplication check process applied to the received packet.

The disclosed processes can differentiate between packets carrying idempotent and non-idempotent operations and mark them as such. Packets carrying idempotent operations can require at least once delivery (AOD). These operations can be safely repeated without changing the overall outcome beyond the initial execution. For example, reading a value is typically an idempotent operation. Packets carrying non-idempotent operations utilize exactly once delivery (EOD). These operations, if repeated, can lead to unintended consequences or incorrect results. Examples include incrementing a counter or setting a synchronization flag. By marking packets as AOD or EOD, deduplication does not have to be enforced indiscriminately for every packet. Deduplication processes can be utilized for EOD packets.

Destination nodes can implement a system to recognize and discard duplicate packets. This can be achieved through a process of signature storage, comparison, or duplicate handling. The destination node can maintain a filter that stores unique signatures of received packets requiring EOD, e.g., a set of unique signatures stored at the node. Each incoming packet's signature can be compared against those stored in the filter. If a match is found, the packet can be identified as a duplicate and ignored. This mechanism ensures that unique packets are processed, maintaining the integrity of non-idempotent operations, and preventing unintended consequences from repeated packet delivery. The set of unique signatures can be reset at a time when the epoch counter is modified, for example, when the epoch counter is incremented, initialized, or reset.

EOD Packets have to provide a unique signature within a given epoch. The destination node can maintain a filter that stores these signatures for the duration of the epoch. When a new packet arrives, its signature can be compared against those in the filter to determine if a duplicate has already been received. The signature can take various forms: (1) Unique Identifier: The signature can be an identifier, such as a sequence number, which is unique with respect to the communication channel, set up between the source and destination nodes, and epoch. (2) Packet Type: The destination node can remember the receipt of a packet of a particular type. If that packet type is transmitted once in an epoch, the destination node can use a flag to indicate its receipt.

The signatures of received non-idempotent packets can be stored in a deduplication filter for the duration of an epoch. There can be a direct correlation between the capacity of the filter and the epoch length, where the epoch length refers to the number of non-idempotent operations received during the epoch. To effectively manage the filter capacity, different strategies can be implemented: (1) Destination-side Filter Overflow Handling: In the event that the filter reaches its capacity limit, the destination node can respond to incoming request packets (REQ) with negative acknowledgment packets (NACKs). NACKs can inform the source node that the filter capacity has been exhausted. Upon receiving this notification, the source node can initiate an advancement of the epoch counter, which in turn can clear the filter and allow for continued operation.
(2) Sender-side Filter Overflow Prevention: To prevent filter overflow from occurring, the source node can employ a proactive approach. It can maintain a count of the non-idempotent operations sent and ensure that this count does not exceed the known capacity of the filter.

Before nodes can communicate with each other, they can establish a channel that facilitates synchronization of their respective epoch counters. A channel can encompass two or more communicating nodes, with each node maintaining a separate epoch counter for every channel it participates in. There can be various approaches to establishing channels: (1) Software-Managed Channels: Software-managed channels can provide a flexible approach. Management can be done by communication libraries, operating systems, or virtual machine (VM) hypervisors. One advantage of software-managed channels can be that they do not require a specific network protocol for channel creation. The software can be responsible for assigning nodes to the appropriate channels and initializing the epoch counters associated with each channel. (2) Protocol-Based Channels: This approach can use control packets to set up and maintain the channels (see, for example, FIGS. 3A-C). Similar methods can be considered for closing a channel.

Advancing the epoch counters can be done in various ways: (1) By Software: In some implementations, software can manage epoch advancement. The system software can advance the counters when it determines that operations belonging to the current epoch have been completed. (2) By Protocol: (a) Implicitly: Epoch counters can be advanced implicitly, often inferred from synchronization operations. (b) Explicitly: Another approach can use dedicated control packets to explicitly advance the epoch counters.

The deduplication processes can be implemented using epochs which can be synchronized using source-based synchronization (e.g., see, for example, FIGS. 3A-C) or using destination-based synchronization (e.g., see, for example, FIGS. 5A-B). The deduplication process can accommodate various types of duplication, for example, resulting from retransmissions caused by dropped or lost packets, or replay attacks. Replay attacks can be when malicious actors intentionally duplicate and retransmit legitimate packets to compromise the integrity of network communications. The epoch-based deduplication techniques disclosed can be used to mitigate replay attacks with further error control logic since replay attacks can duplicate any type of packet. The examples presented focus on duplicate REQs.

Unlike retransmissions, replay attacks can create duplicate ACK (acknowledgment) packets in addition to duplicate REQ packets. To address this issue, mechanisms provided by the transport layer can be leveraged. For example, in one aspect, the processes can implement a tagging system that allows for the matching of ACKs with their corresponding REQs. With such a mechanism in place, the system can accurately identify duplicate ACK packets if its tag is not recognized as corresponding to an outstanding (unacknowledged) REQ.

The use of counted operations to implement bulk data transfers, such as shown in FIGS. 5A-B, can introduce an issue when handling duplicate REQs, particularly in the context of potential replay attacks. While the store operations themselves can be idempotent, the counting mechanism used to track the progress of bulk data transfers is non-idempotent. This distinction can be crucial for maintaining the integrity of the transfer process. Thus, if replay attacks can occur in the presence of counted operations, operations including data transfer and synchronization operations have to be treated as non-idempotent operations.

Turning now to the figures, FIG. 1 is an illustration of a diagram of an example process 100 using epochs for deduplication. The sequence diagram depicts a first node 110 and a second node 115 with an epoch counter 117 initially set to value e. First node 110 and second node 115 are each within epoch e. In this example, a request packet (REQ) 120 is sent from first node 110 to second node 115. An acknowledgment packet (ACK) 125 is lost during transmission. This loss triggers a retransmission of the original REQ as a REQ 130, which is then received by second node 115 for a second time. Second node 115 recognizes REQ 130 as a duplicate of REQ 120 and responds with a negative acknowledgment packet (NACK(DUP)) 135 to indicate the duplication.

FIGS. 2A-2C are illustrations of diagrams of example processes 200 when epochs do not match between the source node and destination node. FIG. 2A demonstrates when an outdated packet is received. FIG. 2B demonstrates when a future epoch packet is received, and the response occurs within the subsequent epoch. FIG. 2C demonstrates when a future epoch packet is received and responded to in a previous epoch. A key 207 shows the relative epoch counters for the source and destination nodes.

FIG. 2A has a first node 210 and a second node 215. First node 210 transmits a REQ 220 for second node 215. Second node 215 receives REQ 220 sent during the previous epoch. Since the packet's epoch is less than the current epoch of the second node 215, the packet is considered to have aged out. As a consequence, second node 215 can ignore the packet and return a negative acknowledgment 225. This scenario can occur, for example, when a packet is resent, but the epoch counters have advanced after the transactions are completed.

FIG. 2B has a first node 230 and a second node 235. A REQ 240 can be sent at a time when first node 230 is at epoch e and received at second node 235 at a time when second node 235 is at epoch e−1, e.g., a previous epoch. Second node 235 can buffer REQ 240 until the epoch counter of second node 235 is advanced to e, for example, if second node 235 has available memory to store REQ 240. An ACK 245 can be sent once second node 235 has processed REQ 240.

FIG. 2C has a first node 250 and a second node 255. A REQ 260 can be sent at a time when first node 250 is at epoch e and received at second node 255 at a time when second node 255 is at epoch e−1, e.g., a previous epoch. Second node 235 can send a negative ACK 265, such as when there are no available resources to store REQ 260.

FIG. 3A is an illustration of a diagram of an example bulk data transfer 301. Bulk data transfer 301 shows two bulk transfers, one originating in epoch e and a subsequent one in epoch e+1. A key 307 shows the different relative epochs. Key 307 shows the previous epoch as a dashed line (e.g., epoch e−1). Key 307 shows the current epoch as a solid line (e.g., epoch e). Key 307 shows the subsequent epoch as a dotted line (e.g., epoch e+1). Data is transferred between first node 310 and second node 315 using multiple request packets containing various operations. A synchronization operation 320 marks the end of the data transfer and signals to second node 315 that the data transfer is complete, and that data can be consumed. More specifically, once first node 310 has accounted for the REQs being acknowledged, a synchronization operation in the form of a DONE/DONEACK exchange can be performed. While data transfers can be idempotent, the synchronization operation is non-idempotent. The synchronization operation can further implicitly advance the epoch counters.

FIG. 3B is an illustration of a diagram of an example bulk data transfer 302 showing ordering requirements. Data transfers can be delivered in various orders, providing flexibility in packet routing and forwarding. The synchronization operation, though, should be ordered with respect to the bulk data transfer. This ordering can be ensured by a first node 330 waiting to send a DONE packet 340 until the data transfers have been completed and ACK received from a second node 335.

FIG. 3C is an illustration of a diagram of an example bulk data transfer 303 for handling duplicates. REQs can carry idempotent operations that can be executed more than once, as shown by a duplicate REQ 370 following a failed ACK 372. DONE packets can constitute a non-idempotent operation that should be executed once. As bulk data transfer 303 illustrates, duplicates may not be caught by the deduplication filter. Bulk data transfer 303 has a first node 360 and a second node 365. A duplicate DONE packet 375 is dropped as it aged out after the first copy of a DONE packet 377 advanced the receiver's epoch counter at a time 380.

FIG. 4A is an illustration of a diagram of an example multiple transfer 401 per epoch. The disclosed processes can be extended to support multiple transfers within a single epoch. This enhancement can be achieved by incorporating a transfer identifier into the packets, as demonstrated in multiple transfer 401. Present are a first node 410 and a second node 415.

In this aspect, distinct transfers, such as a REQ packet t1 420 and a REQ packet t2 422, occur within epoch e, e.g., simultaneously, overlapping, serially, or in other combinations. The addition of transfer identifiers allows the system to differentiate between packets belonging to different transfers, even when they share the same epoch. Packets from the transfers can be interleaved during transmission, allowing for better utilization of network resources by enabling concurrent transfers. To implement unique signatures when multiple transfers per epoch are to be supported, the following options can be considered: (1) The sender can guarantee that every packet independent of its transfer identification (ID) can carry a unique identifier. (2) Packet IDs can be unique within a transfer and the deduplication filter stores tuples (transfer ID, packet ID). Multiple transfer 401 demonstrates that the epoch counters can be explicitly advanced by a control packet, such as a synchronization packet (SYN) 430.

FIG. 4B is an illustration of a diagram of an example multiple transfer 402 per epoch. Multiple transfer 402 demonstrates that the system can rely on tracking the completion of transfers. Present are a first node 440 and a second node 445. The system can monitor DONE messages, such as a DONE ACK 450a and a DONE ACK 450b, to indicate the completion of individual transfers. When the expected transfers within an epoch are completed, the advancement of the epoch counter can be triggered. Counting the synchronization messages can be done with hardware or software.

FIG. 5A is an illustration of a diagram of an example destination node synchronization 501. The source node synchronization method previously discussed can introduce a delay of one round-trip time (RTT) from the arrival of the last data packet and the completion of the synchronization operation. To eliminate this delay and improve efficiency, synchronization at the destination node can be implemented using a counted writes process.

The bulk data transfer in this demonstration comprises three REQ packets (520a, 520b, and 520c), which can be followed by a synchronization operation. The synchronization operation, embodied in a DONE packet 522, can specify a count of four, which includes REQ 520a, REQ 520b, and REQ 520c and DONE packet 522. At the beginning of the epoch, a second node 515 can initialize a packet counter 530 to zero, preparing to track the incoming packets. As each packet is received, whether it's a data packet or a DONE packet, second node 515 can increment packet counter 530. The system can continuously monitor packet counter 530, comparing it to the terminal count specified in DONE packet 522. When the terminal count is reached, the transfer can be deemed complete. At this point, second node 515 can return a DONE ACK 524 to a first node 510, confirming the successful completion of the entire transfer.

FIG. 5B is an illustration of a diagram of an example destination node synchronization 502 with out-of-order packets. Destination node synchronization 501 demonstrates the scenario where packets arrive in order without packet loss. Destination node synchronization 502 demonstrates an out-of-order packet delivery from a first node 540 to a second node 545. In some aspects, the REQ packets can be delivered out of order. In some aspects, at least one of the REQ packets (e.g., a REQ 550) can be delivered out of order with respect to a corresponding DONE packet 552. The synchronization operation should not be executed before the appropriate data packets are received. The synchronization operation (e.g., a DONE ACK packet 554) can be delayed until the appropriate REQ packets have been received. A packet counter 560 can maintain the packet count regardless of the order the packets were received in.

FIG. 6A is an illustration of a diagram of an example lost packet protocol 601. Lost packet protocol 601 demonstrates one way the processes can recover from lost packets. In this aspect, the data REQ packets should be non-idempotent. A data REQ packet 620 is lost and resent as a REQ 622 after a packet timeout timer 625 has expired. As a DONE packet 627 arrives when the terminal count has not yet been reached, the corresponding synchronization operation can be delayed until REQ 622 is received. This ensures that the data packets are accounted for before completing the transfer.

FIG. 6B is an illustration of a diagram of an example lost packet protocol 602. Lost packet protocol 602 demonstrates a second way the processes can recover from lost packets, specifically, where an ACK packet 640 is lost. This triggers the retransmission of a corresponding REQ 642 at a time when packet timeout counter 647 ends. A second node 635 proceeds processing since the original REQ and DONE packets were delivered. When REQ 642 arrives, it can be recognized as expired (e.g., using a NACK (EXP) packet 645) since the epoch counter has already been incremented.

FIG. 6C is an illustration of a diagram of an example lost packet protocol 603. Lost packet protocol 603 demonstrates a third way the processes can recover from lost packets, specifically, where a DONE ACK 670 is lost. A second node 665 proceeds and completes the transfer after the original REQ and DONE packets arrive. When a DONE packet 672 is retried, second node 665 recognizes it as expired and sends a DONE NACK 675. Since a first node 660 has not yet received a DONE ACK packet, first node 660 derives from the receipt of DONE NACK 675 that the transfer process has completed earlier and the epoch counter can be advanced.

FIG. 7A is an illustration of a diagram of an example lost packet protocol 701 demonstrating a process that does not need non-idempotent REQ packets. Lost packet protocol 701 has the advantage that it requires less deduplication. A SYN control packet can be used to reset and resynchronize the state in first node 710 and second node 715. Lost packet protocol 701 includes a key 707 that extends key 307 with a grey dashed line indicating an epoch e+2.

For this demonstration, a REQ 720 is lost. Consequently, a DONE packet 722 is not processed as the terminal count is not reached. Once the outstanding transactions have completed or timed out (e.g., at a timeout 725 representing REQ 720 timing out and a timeout 730 representing DONE packet 722 timing out), a SYN packet 724 is sent, instructing second node 715 to increment its epoch counter. Upon receiving a SYN ACK 726, first node 710 advances its respective epoch counter. At this point, unacknowledged REQ and DONE packets 728 are retransmitted with the new epoch value and updated packet count.

FIG. 7B is an illustration of a diagram of an example lost packet protocol 702 demonstrating waiting for the completion of the SYN/SYN ACK handshake before retrying transactions. In this aspect, when a first node 750 sends a SYN packet 770, it considers two transactions to be outstanding, since an ACK 772 and a DONE ACK 774 have not been received. Second node 755 has already received and executed the corresponding REQ and DONE operations, a REQ 776 and a DONE 778. The synchronization operation has been executed, resulting in the advancement of the epoch counter for second node 755. Therefore, when second node 755 receives SYN packet 770, second node 755 responds with a SYN NACK(EPERR) packet 780. This response indicates an ‘epoch error’, signifying that the epoch counter has already been incremented. The SYN NACK indirectly tells first node 750 that the bulk data transfer was completed and, therefore, the transactions had been completed.

FIG. 8 is an illustration of a diagram of an example collective 800 to demonstrate a channel that comprises more than two nodes. The sequence diagram of collective 800 implements an AllReduce collective operation to apply a sum operation. Collective 800 is a simplified example and omits other necessary initialization steps and assumes a straightforward push model where nodes utilize (non-idempotent) atomic add operations to accumulate values in switch memory. Similar to counted writes, the switch counts the atomic add operations to determine when the values have been received, and the sum can be broadcast back to the participating nodes.

Collective 800 shows a typical case without packet loss, with a first node 810, a second node 815, and a switch node 817. In some aspects, additional nodes can be included in the messaging system. In some aspects, each set of nodes can utilize different epoch counters. The broadcast of the sum also serves as a synchronization operation that implicitly advances the epoch counters. Various error scenarios can be incorporated into the collective operations, such as error scenarios described in this disclosure, for example, various types of packet losses.

FIG. 9 is an illustration of a flow diagram of an example method 900 to perform a deduplication process of a packet of data. Method 900 can be performed on a computing system, for example, epoch system 1000 of FIG. 10 or epoch controller 1100 of FIG. 11. The computing system can be one or more computing networks, one or more processors in various combinations (e.g., CPUs, GPUs, SIMDs, or other types of processors), a data center, a cloud environment, a server, a laptop, a mobile device, a smartphone, a PDA, or other computing system capable of receiving a packet of data over a computing network, and capable of managing an epoch. Method 900 can be encapsulated in software code or hardware, for example, an application, code library, code module, dynamic link library, module, function, RAM, ROM module, and other software and hardware implementations. The software can be stored in a file, database, or other computing system storage mechanism. Method 900 can be partially implemented in software and partially in hardware. Method 900 can perform the steps for the described processes, for example, identifying a unique signature of a packet of data, the epoch for the packet of data, and performing a deduplication process if needed.

Method 900 starts at a step 905 and proceeds to a step 910. In step 910, a packet handling protocol can be established at a node communicatively coupled to the computing network or between at least two nodes communicatively coupled to the computing network. The packet handling can at least specify that epochs will be used, how many entries the deduplication filter contains, and how negative acknowledgments will be handled by the nodes (e.g., what actions to take). In some aspects, the packet handling protocol can specify what action to take when a packet of data arrives either prior to or after its assigned epoch. In some aspects, the packet handling protocol can specify what happens when a packet of data fails to be received by the intended receiver node, e.g., error handling protocols.

In a step 915, a node can receive a packet of data and begin the process to handle or process the packet of data. In some aspects, a source node can transmit the packet of data to a destination node.

In a step 920, the packet of data needs to be identified. In some aspects, the identification can be a unique signature included in the packet of data. In some aspects, the identification can be a combination of a packet type and a packet sequence identification. In some aspects, the packet can include a total of the number of packets that will be received in the set of packets of data. In some aspects, the packet can include an epoch value indicating in which epoch the packet of data belongs. In some aspects, the process can identify whether the packet of data is non-idempotent.

In a step 925, the destination node can determine an action for the packet of data by comparing the epoch value to a current value of the epoch counter being tracked at the destination node. In some aspects, the packet of data can be ignored. In some aspects, the packet of data can be buffered for use in a subsequent epoch. In some aspects, the packet of data can be processed through a deduplication filter. The deduplication filter can check whether the unique signature of the packet of data exists in a set of unique signatures stored at the destination node. If the packet of data has already been received, based on the unique signature check, and is non-idempotent, then the packet of data can be deduped, e.g., ignored or deleted. Method 900 ends at a step 995.

FIG. 10 is an illustration of a block diagram of an example epoch system 1000. Epoch system 1000 can be implemented in one or more computing systems, computing networks, or one or more processors. In some aspects, epoch system 1000 can be implemented using an epoch controller such as epoch controller 1100 of FIG. 11. Epoch system 1000 can implement one or more aspects of this disclosure, such as method 900 of FIG. 9.

Epoch system 1000, or a portion thereof, can be implemented as an application, a code library, a dynamic link library, a function, a module, a header file, other software implementations, or combinations thereof. In some aspects, epoch system 1000 can be implemented in hardware, such as a ROM, a graphics processing unit, or other hardware implementation. In some aspects, epoch system 1000 can be implemented partially as a software application and partially as a hardware implementation. Epoch system 1000 is a functional view of the disclosed processes, and an implementation can combine or separate the functions in one or more software or hardware systems.

Epoch system 1000 demonstrates two computing systems that are communicating with each other over a computing network 1005. Computing network 1005 can be one or more of various types of networks, such as an internet, an intranet, or an extranet, and be implemented using wired, wireless, or a combination of network types, and utilize various communication protocols that allow for or support epoch processes for packets of data. A computing system 1010 and a computing system 1020 are shown. Computing system 1010 or computing system 1020 can be one or more various types of computing systems, for example, a data center, a cloud environment, a server, a mobile phone, a laptop, a headphone, a communications tower, a base station, a satellite, a vehicle, a spacecraft, a water craft, or other types of computing systems capable communicating over a computing network with another computing system.

Computing system 1010 has a data transceiver 1012, an epoch processor 1014, and a result transceiver 1016. Computing system 1020 has a data transceiver 1022, an epoch processor 1024, and a result transceiver 1026. The output, e.g., a packet of data, for example, a data packet, a synchronization packet, a done packet, or an acknowledgment packet, can be communicated to the other computing system. The output can be processed by the receiving computing system and appropriate action can be taken utilizing the information stored in the packet of data or utilizing the type of packet of data (for example, whether it is an ACK or NACK packet).

In some aspects, the packet handling protocol can be specified by the protocols of computing network 1005. In some aspects, the packet handling protocol can be specified by the initiating computing system, when it transmits a first packet of data. In some aspects, the packet handling protocol can be specified by the receiving computing system, for example, specifying a time interval for each epoch utilizing the amount of memory allocation available and the expected number of non-idempotent packets of data to be received. Data transceiver 1012 and data transceiver 1022 can receive packets of data from the other computing system. In some aspects, data transceiver 1012 can be part of epoch processor 1014. In some aspects, data transceiver 1022 can be part of epoch processor 1024.

Result transceiver 1016 (e.g., a transmitter) can communicate one or more outputs (such as packets of data), to one or more data receivers, such as result transceiver 1026. Result transceiver 1026 (e.g., a transmitter) can communicate one or more outputs (such as packets of data), to one or more data receivers, such as result transceiver 1016. Data transceiver 1012, epoch processor 1014, result transceiver 1016, data transceiver 1022, epoch processor 1024, or result transceiver 1026 can be, or can include, conventional interfaces configured for transmitting and receiving data. Data transceiver 1012, epoch processor 1014, result transceiver 1016, data transceiver 1022, epoch processor 1024, or result transceiver 1026 can be implemented as software components, for example, a virtual processor environment, as hardware, for example, circuits of an integrated circuit, or combinations of software and hardware components and functionality. The functionality described for these components remains intact regardless of how the functionality is implemented.

Epoch processor 1014 and epoch processor 1024 (e.g., one or more processors such as processor 1130 of FIG. 11) can implement the analysis and algorithms as described herein utilizing the epoch parameters. Epoch processor 1014 or epoch processor 1024 can be one or more of a multicore processor, a multiprocessor system, or a streaming multiprocessor. Epoch processor 1014 or epoch processor 1024 can be implemented by a central processor unit (CPU), a graphics processor unit (GPU), or other types of processors. Epoch processor 1014 or epoch processor 1024 can be a non-transitory computer program product having a series of operating instructions stored on a non-transitory computer-readable medium that directs a packet of data handling apparatus when executed thereby to perform operations as disclosed herein.

A memory or data storage system of epoch processor 1014 or epoch processor 1024 (such as a core cache, L1 cache, L2 cache, or other memory systems) can be configured to store the processes and algorithms for directing the operation of epoch processor 1014 or epoch processor 1024. Epoch processor 1014 or epoch processor 1024 can include a processor that can be configured to operate according to the analysis of operations and algorithms disclosed herein, and an interface to communicate (transmit and receive) data.

FIG. 11 is an illustration of a block diagram of an example of an epoch controller 1100 according to the principles of the disclosure. Epoch controller 1100 can be stored on one computer or multiple computers. The various components of epoch controller 1100 can communicate via wireless or wired conventional connections. A portion or a whole of epoch controller 1100 can be located at one or more locations. In some aspects, epoch controller 1100 can be part of another system (e.g., processor, core, server, or other systems), and can be integrated with one device, such as a part of a processing system. Epoch controller 1100 represents a demonstration of the functionality employed for the disclosure, and implementations can use a variety of devices, for example, circuits of a processor, dedicated processors, network interface cards, virtual systems, servers, other computing or processing systems, be in software or hardware, or various combinations thereof.

Epoch controller 1100 can be a representation of one node communicatively coupled to a computing network, where epoch controller 1100 is communicating with at least one other node also communicatively coupled to the computing network. Epoch controller 1100 can be configured to perform the various functions disclosed herein including receiving input parameters and generating results from the execution of the methods and processes described herein, such as handling and processing received packets of data, determining an action using the received packet of data, and transmitting a new packet of data. Epoch controller 1100 includes a communications interface 1110, a memory 1120, and a processor 1130.

Communications interface 1110 can be configured to transmit and receive data, such as the packets of data over the computing network. For example, communications interface 1110 can receive the input parameters. The input parameters can be instructions or directions for establishing epochs and a time interval for each epoch. Communications interface 1110 can transmit the output or interim outputs, such as packet of data. In some aspects, communications interface 1110 can transmit a status, such as a success or failure indicator of epoch controller 1100 regarding receiving the various inputs, transmitting the generated outputs, or producing the results.

In some aspects, processor 1130 can perform the operations as described by epoch processor 1014 or epoch processor 1024. Communications interface 1110 can communicate via communication systems used in the industry. For example, wireless or wired protocols can be used. Communication interface 1110 can perform the operations as described for data transceiver 1012, data transceiver 1022, result transceiver 1016, or result transceiver 1026 of FIG. 10.

Memory 1120 can be configured to store a series of operating instructions that direct the operation of processor 1130 when initiated, including supporting code representing the algorithm for handling packets of data. Memory 1120 can be a non-transitory computer-readable medium. Multiple types of memory can be used for the data storage systems and memory 1120 can be distributed. In some aspects, memory 1120 can be used to store the set of unique signatures that is used to perform the deduplication filtering.

Processor 1130 can be one or more processors. Processor 1130 can be a combination of processor types, such as a CPU, a GPU, a network processor, a single instruction multiple data (SIMD) processor, or other processor types. Processor 1130 can be configured to produce the output, one or more interim outputs, and statuses utilizing the received inputs. Processor 1130 can determine the output using parallel processing. Processor 1130 can be an integrated circuit. In some aspects, processor 1130, communications interface 1110, memory 1120, or various combinations thereof, can be an integrated circuit. Processor 1130 can be configured to direct the operation of epoch controller 1100. Processor 1130 includes the logic to communicate with communications interface 1110 and memory 1120, and perform the functions described herein. Processor 1130 can be capable of performing or directing the operations as described by epoch processor 1014 or epoch processor 1024 of FIG. 10.

For example, in some aspects, epoch system 1000 or epoch controller 1100 can be part of a system, a process, a processor unit, a processor core, a chip, a circuit board, a network, or an application, or can be accessed remotely, such as a code library, remote function, or remote process. In some aspects, epoch system 1000 or epoch controller 1100 can be part of another system that receives packets of data. For example, in some aspects, epoch system 1000 or epoch controller 1100 can be part of a machine learning system, an AI generative tool, or can be in a data center, a cloud system, an edge system, a corporate system, or other type of system or location. In some aspects, epoch system 1000 or epoch controller 1100 can be part of a machine learning system, where the epoch processor can be part of the machine learning processes. In some aspects, epoch system 1000 or epoch controller 1100 can implement a non-transitory computer program product having a series of operating instructions stored on a non-transitory computer-readable medium that directs a data processing apparatus when executed thereby to perform operations, the operations comprising the steps described herein for this disclosure, such as method 900 of FIG. 9.

A portion of the above-described apparatus, systems, or methods can be embodied in or performed by various digital data processors or computers, wherein the computers are programmed or store executable programs of sequences of software instructions to perform one or more of the steps of the methods. The software instructions of such programs can represent algorithms and be encoded in machine-executable form on non-transitory digital data storage media, e.g., magnetic or optical disks, random-access memory (RAM), magnetic hard disks, flash memories, or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs can be included on a graphics card that includes one or more memory devices and is configured to interface with the motherboard of a computer. The GPUs can be integrated GPUs (iGPUs) that are co-located with a CPU on one chip. Configured or configured to means, for example, designed, constructed, or programmed, with the necessary logic or features for performing a task or tasks.

Portions of disclosed examples or embodiments can relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic or features for performing a task or tasks. Examples of program code include machine code, such as produced by a compiler, and files containing higher-level code that can be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, utilized, or combined with other elements, components, or steps that are not expressly referenced.

Those skilled in the art to which this application relates will appreciate that other and further additions, deletions, substitutions, and modifications can be made to the described embodiments. It is also to be understood that the terminology used herein is to describe particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A method, comprising:
establishing a packet handling protocol at a node, wherein the packet handling protocol specifies using an epoch counter at the node, the node is communicatively coupled to a computing network, and the epoch counter is initialized to a current value;
receiving a packet of data at the node, wherein the packet of data is non-idempotent and includes an epoch value; and
determining an action for the packet of data by comparing the epoch value to the current value of the epoch counter.

2. The method as recited in claim 1, wherein the packet of data further includes a unique signature, and the determining further uses the unique signature to determine the action.

3. The method as recited in claim 2, wherein the unique signature is a sequence number or a packet type.

4. The method as recited in claim 2, wherein the unique signature is a combination of a transfer identification and a packet sequence identification, and a set of unique signatures stores the unique signature as a tuple.

5. The method as recited in claim 2, wherein the action is a deduplication check at the node when the epoch value matches the epoch counter, further comprising:
performing the deduplication check by comparing the unique signature to a set of unique signatures stored at the node; and
processing the packet of data when the unique signature does not exist in the set of unique signatures.

6. The method as recited in claim 5, further comprising:
resetting the set of unique signatures at a time when the current value of the epoch counter is modified.

7. The method as recited in claim 1, wherein the action further comprises:
ignoring the packet of data when the epoch value is a previous epoch when compared to the current value of the epoch counter.

8. The method as recited in claim 1, wherein the action further comprises:
buffering the packet of data when the epoch value is a future epoch when compared to the current value of the epoch counter.

9. The method as recited in claim 1, further comprising:
informing the node of a change in the current value of the epoch counter using a parameter included with the packet of data.

10. The method as recited in claim 1, wherein the action further comprises:
incrementing the current value of the epoch counter when an epoch time interval is reached; and
resetting the epoch time interval.

11. The method as recited in claim 1, wherein the action further comprises:
transmitting a negative acknowledgment packet from the node when a memory allocation for a set of unique signatures reaches capacity; and
receiving a second packet of data at the node, wherein the second packet of data indicates that the node is to increment the current value of the epoch counter.

12. The method as recited in claim 1, wherein the action further comprises:
incrementing the current value of the epoch counter at the node when a count of non-idempotent operations received exceeds a capacity of a memory allocation for a set of unique signatures.

13. The method as recited in claim 1, wherein the action further comprises:
incrementing the current value of the epoch counter at the node when a number of received packets of data equals a packet count, where the packet count is specified in the packet of data; and
resetting the packet count.

14. The method as recited in claim 1, wherein the node is a second node, further comprising:
transmitting the packet of data across the computing network from a first node, wherein the first node is communicatively coupled to the computing network.

15. The method as recited in claim 14, further comprising:
incrementing a value of a first epoch counter of the first node when an acknowledgement packet is received from the second node.

16. The method as recited in claim 15, wherein the acknowledgement packet is a negative acknowledgment packet.

17. The method as recited in claim 14, wherein a protocol-based channel is used to set up a channel between the first node and the second node, where the protocol-based channel describes at least one of a parameter for an epoch time interval, handling of epoch synchronization, or handling of acknowledgment packets and negative acknowledgment packets.

18. The method as recited in claim 1, wherein more than two nodes are communicatively coupled on the computing network.

19. The method as recited in claim 18, wherein the more than two nodes transmit a collective operation and a transmission of a result provides synchronization between respective epoch counters for each node in the more than two nodes.

20. A system, comprising:
a first node on a computing network capable of transmitting and receiving packets of data over the computing network; and
a second node on the computing network capable of transmitting and receiving the packets of data over the computing network, wherein the second node utilizes an epoch counter, the packets of data include at least one non-idempotent packet of data, and the at least one non-idempotent packet of data includes an epoch value and a respective unique signature, and determining an action for the at least one non-idempotent packet of data by comparing the epoch value to the epoch counter.

21. The system as recited in claim 20, wherein computing network is an intranet, an internet, or an extranet.

22. The system as recited in claim 20, wherein the computing network couples chips, processors, or circuit boards.

23. A non-transitory computer program product having a series of operating instructions stored on a non-transitory computer-readable medium that directs packet deduplication when executed thereby to perform operations, the operations comprising:
establishing a packet handling protocol at a second node, wherein the packet handling protocol specifies using an epoch counter at the second node, and the second node is communicatively coupled to a computing network;
transmitting a packet of data across a computing network from a first node, wherein the first node is communicatively coupled to the computing network;
receiving a packet of data at the second node, the packet of data is non-idempotent, and the packet of data includes an epoch value and a unique signature; and
determining an action for the packet of data by using the unique signature and comparing the epoch value to the epoch counter.

24. The non-transitory computer program product recited in claim 23, wherein the action is a deduplication check at the second node when the epoch value matches the epoch counter, further comprising:
performing the deduplication check by comparing the unique signature to a set of unique signatures stored at the second node;
ignoring the packet of data when the unique signature exists in the set of unique signatures; and
resetting the set of unique signatures at a time when the epoch counter is modified.
